(19) United States
(12) Patent Application Publication
(10) Pub. No.: US 2018/0199646 A1
(43) Pub. Date: Jul. 19, 2018

(54) POCKET SYSTEM FOR WADERS

(71) Applicant: Michael Myers, La Pine, OR (US)

(72) Inventor: Michael Myers, La Pine, OR (US)

(21) Appl. No.: 15/873,298

(22) Filed: Jan. 17, 2018

Related U.S. Application Data
(60) Provisional application No. 62/447,258, filed on Jan. 17, 2017.

(51) Int. Cl. A41D 27/20; A01K 97/06; A41D 13/012; A41D 3/00

(52) U.S. Cl. CPC A41D 27/207; A01K 97/06; A41D 13/012; A41D 27/201; A41D 2400/48; A41D 3/00; A41D 2300/30; A41D 2300/32; A41D 2400/22; A41D 27/208

(57) ABSTRACT

A wader with pocket system includes a large center pocket has a hard outer cover and will hold a variety of accessories including fly dressing, fly holder, clippers, leaders, and leader wheels. The top of the hard cover opens and folds down to make a platform where a fisherman can choose what he needs and have an organized working area that will support his needed products without them falling in the water. An accessory pocket adjacent to the large center pocket used for containing accessories and equipment. A plurality of accessory holders, between 1″ and 3″ wide, each include a strip of waterproof, breathable fabric sewn to the wader at each end creating a loop suitable for holding accessories. The accessory holders can hold accessory insert sheaths that close at the bottom and are designed to take a variety of different accessory items that pertain to fishing, hunting, or other activities that require waders.

### CROSS REFERENCE TO RELATED APPLICATION

The present application claims the benefit of, and priority to, co-pending U.S. Provisional Application Ser. No. 62/447,258, filed 17 Jan. 2017, incorporated herein by reference.

### FIELD OF THE INVENTION

This specification relates to waders. More particularly, the present specification relates to a pocket system for waders.

### BACKGROUND

Waders are generally a waterproof item of clothing typically worn by hunters, fishermen, and others when performing activities while in the water. They are used for protection against the weather and the water when the hunter/fisherman expects to spend a long time in the water without leaving the activity they are engaged in. When they do leave the water it is typically to get tools or equipment that they couldn't bring with them while wearing waders.

It takes times to leave the water to exchange lures, tools, or other equipment and then return. This is time that could be better spent enjoying the intended activity. Though some waders have pockets, these are generic and do not easily hold multiple lures or equipment that need to remain organized. They also do not provide a horizontal platform or shelf that can be used to assemble and disassemble the lures and equipment.

What is needed is a way for the enthusiast to bring their equipment with them. Further, it would be beneficial to have a shelf or platform to assemble and disassemble such equipment as required. This would save time and increase enjoyment.

### SUMMARY

A pocket system for waders located on the front of the wader includes a large center pocket, an accessory pocket, and a plurality of accessory holders.

The large center pocket can hold a number of implements such as lures and is comprised of a hard shell that opens up to provided a horizontal platform that can be used to assemble and disassemble implements. The accessory pocket can hold tools and implements. The accessory holders are used for holding implements such as pliers, and scissors.

The pocket system allows for storing implements as well as assembling, disassembling and installing implements thereby eliminating the need to leave the water and interrupting the engaged activity. The hard outer cover of the center pocket provides a sturdy platform for changing implements and has an edge that prevents the implements from falling in the water. The accessory pocket and accessory holders are made of a breathable, waterproof fabric so that the tools and implements do not get wet until they are ready to be used.

### BRIEF DESCRIPTION OF THE DRAWINGS

The accompanying drawings, which are incorporated into and constitute a part of this specification, illustrate one or more embodiments of the inventive subject matter and, together with the detailed description, serve to explain the principles and implementations thereof. Like reference numbers are used to designate identical, corresponding, or similar components in different figures.

FIG. 1 is a three quarter side view of the wader and pocket system with the center pocket in the open, horizontal platform position.

FIG. 2 is a front view of the large center pocket in the open, horizontal platform position. The pocket contains the fly organizer accessory.

FIG. 3 is a front view of the accessory pocket, adjacent to the hard center pocket, and the accessory holder.

FIG. 4 is a front view of the accessory pocket and the left side accessory holder with the accessory holder containing a pair of scissors.

FIG. 5 is a side view of the scissors accessory.

FIG. 6 is the scissors accessory in an accessory insert sheaf.

FIG. 7 is an upward view of the scissors accessory in an accessory insert sheaf inserted into a accessory holder.

FIG. 8 is a front view of the scissors accessory in an accessory insert sheaf inserted into a accessory holder.

### REFERENCE NUMBERS

| | | | |
|---|---|---|---|
| 2 | Large center pocket | 4 | Accessory holder |
| 6 | Accessory pocket | 8 | Large center pocket in |
| | | | horizontal platform position |
| 10 | Large center pocket storage | 12 | Large center pocket zipper |
| 14 | Cloth stops for large | 16 | Fishing lure organizer insert |
| | center pocket | | |
| 18 | Hard outer surface of large | 20 | Suspender system |
| | center pocket | | |
| 22 | Scissor accessory in accessory | 24 | Scissor accessory |
| | holder | | |
| 26 | Accessory insert sheaf | 28 | Insert sheaf flap |
| 30 | Scissor accessory in accessory | 32 | Front view of scissor acces- |
| | insert sheaf in accessory holder | | sory in accessory insert sheaf |
| | | | in accessory holder |

### DETAILED DESCRIPTION

A wader with pocket system includes a large center pocket has a hard outer cover and will hold a variety of accessories including fly dressing, fly holder, clippers, leaders, and leader wheels. The top of the hard cover opens and folds down to make a platform where a fisherman can choose what he needs and have an organized working area that will support his needed products without them falling in the water. An accessory pocket adjacent to the large center pocket used for containing accessories and equipment. A plurality of accessory holders, between 1″ and 3″ wide, each include a strip of waterproof, breathable fabric sewn to the wader at each end creating a loop suitable for holding accessories. The accessory holders can hold accessory insert sheaths that close at the bottom and are designed to take a variety of different accessory items that pertain to fishing, hunting, or other activities that require waders.

FIG. 1 is a three quarter side view of the wader of the present invention. In this embodiment, the pocket system has a large center pocket 2, an accessory pocket 6, and two accessory holders 4. The large center pocket is in the open, horizontal platform position 8. The accessory pocket 4 is adjacent and to the left of the large center pocket. Both pockets are sewn to the wader with breathable, waterproof fabric and are fastened and held closed using magnets. The accessory pocket is made of breathable, waterproof fabric. There are two accessory holders 4 located above and to the right and left of the large center pocket, respectively. They are sewn to the wader on each end of each accessory holders creating a loop for holding implements.

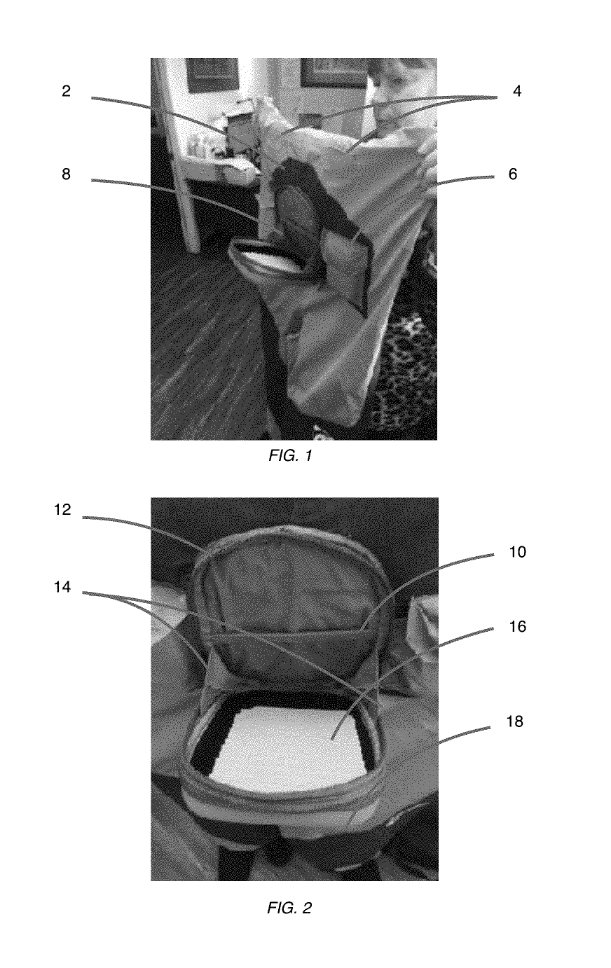

FIG. 2 is a front view of the large center pocket. It has a storage area 10 on the inside of the pocket. In this embodiment, there is a zipper 12 that starts at the bottom and continues over the top to open the platform. The front of the pocket rests in the horizontal position because of cloth stops 14 which are made of waterproof, breathable fabric. Insert 16 is an organizer for fishing lures. The hard outer cover 18 of the pocket functions as the horizontal platform for holding and assembling the lures, and implements.

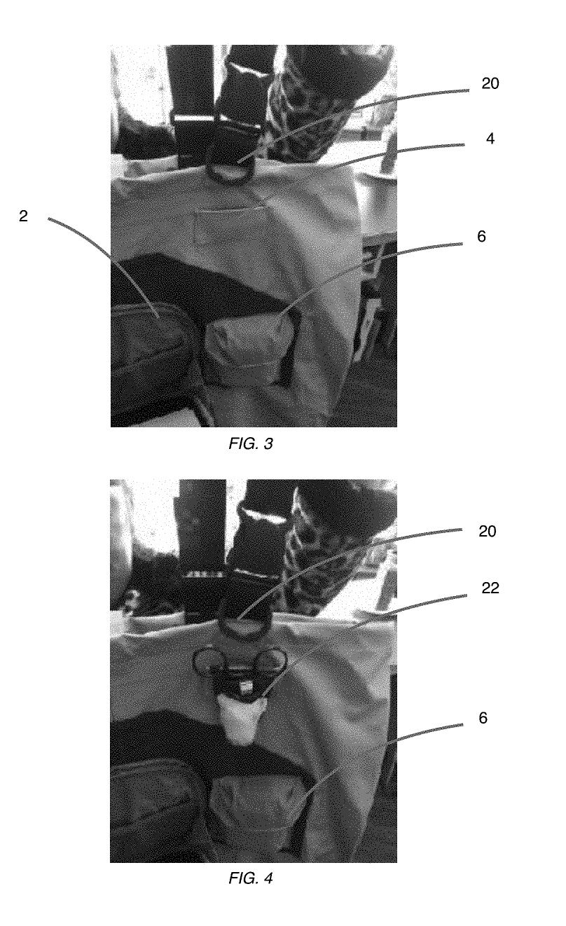

FIG. 3 is a front view of the accessory pocket 6 and a accessory holder 4. Accessory pocket 6 is between 1″ and 3″ deep and is made of waterproof, breathable fabric. Accessory holder 4 is below the suspender system 20 and is made of a strip of waterproof, breathable fabric. Both ends of accessory holder 4 are sewn to the wader to create a horizontal loop that can hold implements. In this embodiment, accessory pocket 6 is below the accessory holder 4.

FIG. 4 is a front view of the accessory pocket 6 and the left side accessory holder 4 that is containing an accessory 22.

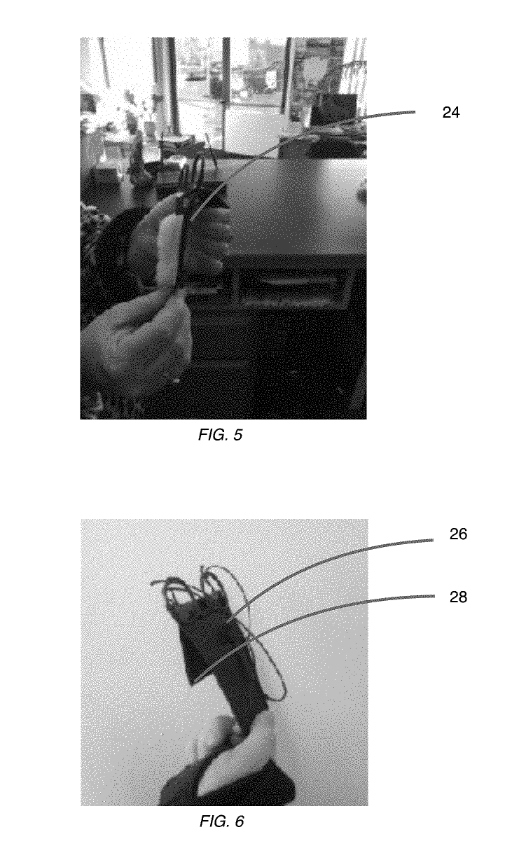

FIG. 5 is a side view of the scissors accessory 24.

FIG. 6 is a front view of the scissors accessory 24 in an accessory insert sheaf 26 that shows the insert sheaf flap 26.

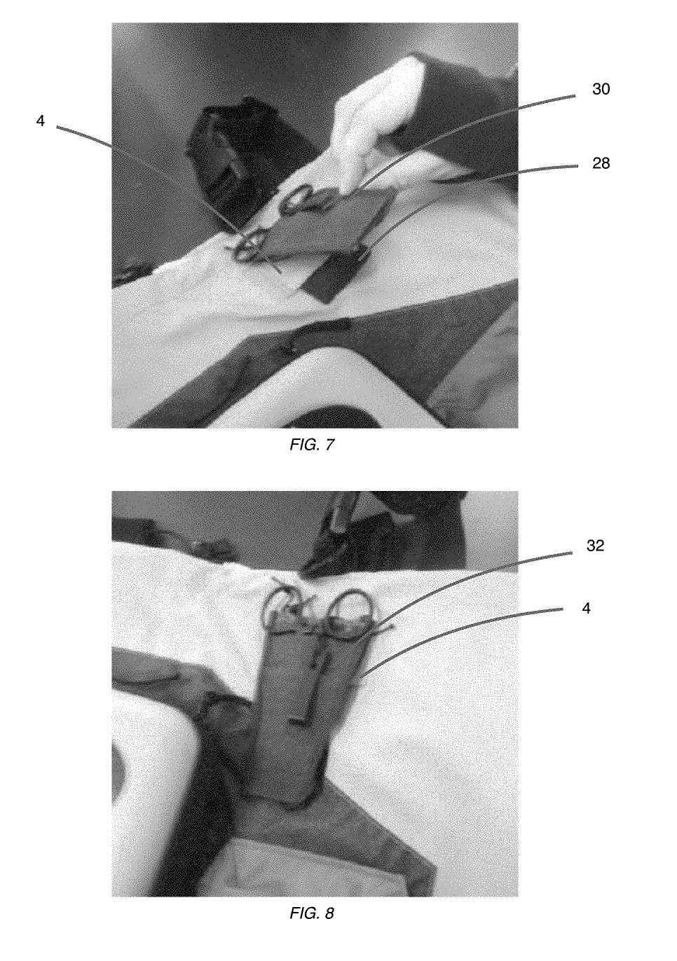

FIG. 7 is an upward view of the scissors accessory in the accessory insert sheaf 30 placed with the insert flap 28 into the accessory holder 4.

FIG. 8 is a front view of the scissors accessory in the accessory insert sheaf 30 in the accessory holder 4.

### First Representative Embodiment

One embodiment of the pocket system for waders comprises a large center pocket, an accessory pocket, and two accessory holders. The large center pocket is two inches deep and has a hard outer cover that opens outward into a platform position. The sides of the hard outer cover are between 1″ and 2″ deep so that in the platform position they form sides so that the tools and accessories don't fall in the water. The pocket closes and is held closed using magnets.

The accessory pocket is to the left of the large center pocket. It is made of breathable waterproof fabric. It is between 3″ and 4″ high and 3″ and 4″ wide and 2″ deep. It has a cover from the top that closes and is held closed using magnets.

The two accessory holders are located above and to the right and left of the large center pocket. They are made of breathable, waterproof fabric. They are comprised of a strip of the breathable, waterproof fabric that is sewn to the wader at each end creating a horizontal loop that can hold an accessory.

### Second Representative Embodiment

Another embodiment of the pocket system for waders comprises a large center pocket, an accessory pocket, and two accessory holders.

The large center pocket is two inches deep and has a hard outer cover that opens outward into a platform position. The sides of the hard outer cover are between 1″ and 2″ deep so that in the platform position they form sides so that the tools and accessories don't fall in the water. The pocket closes and is held closed using one or more hook and loop fasteners such as Velcro™.

The accessory pocket is to the left of the large center pocket. It is made of breathable waterproof fabric. It is between 3″ and 4″ high and 3″ and 4″ wide and 2″ deep. It has a cover from the top that closes and is held closed using one or more hook and loop fasteners such as Velcro™.

The two accessory holders are located above and to the right and left of the large center pocket. They are made of breathable, waterproof fabric. They are comprised of a strip of the breathable, waterproof fabric that is sewn to the wader at each end creating a horizontal loop that can hold an accessory.

### Third Representative Embodiment

Another embodiment comprises a wader with a pocket system. The pocket system comprises a large center pocket, an accessory pocket, and two accessory holders.

The large center pocket is two inches deep and has a hard outer cover that opens outward into a platform position. The sides of the hard outer cover are between 1″ and 2″ deep so that in the platform position they form sides so that the tools and accessories don't fall in the water. The pocket closes and is held closed using magnets.

The accessory pocket is to the left of the large center pocket. It is made of breathable waterproof fabric. It is between 3″ and 4″ high and 3″ and 4″ wide and 2″ deep. It has a cover from the top that closes and is held closed using magnets.

The two accessory holders are located above and to the right and left of the large center pocket. They are made of breathable, waterproof fabric. They are comprised of a strip of the breathable, waterproof fabric that is sewn to the wader at each end creating a horizontal loop that can hold an accessory.

I claim:

1. A wader pocket system comprising:
a large center pocket, an accessory pocket, and a plurality of accessory holders wherein
said large center pocket is between 2″ and 3″ deep with a hard outer cover that is between 1½″ and 2″ deep to form sides to prevent items from falling in the water when opened, that opens from the bottom around the top to make the top become a shelf;
said accessory pocket is adjacent to said large center pocket, is made of waterproof breathable fabric, and is between 2″ and 3″ deep;
said accessory holders are strips made from waterproof, breathable fabric that are sewn on each end of each accessory holder to the wader horizontally forming loops, each loop suitable for holding accessories such as scissors;
with an accessory insert sheaf that an accessory can fit into that has a flap that fits into the accessory holder securely holding the accessory.

2. The wader pocket system of claim 1, wherein the large center pocket and the accessory pocket are fastened and held closed using magnets.

3. The wader pocket system of claim 1, wherein the large center pocket and the accessory pocket are fastened and held closed using one or more hook and loop fasteners.

4. The wader pocket system of claim 2 or claim 3, wherein the large center pocket contains an insert that is suitable for holding accessories such as fishing lures, fishing flys, and tools.

5. An outfit comprising a wader and a pocket system attached to the wader; the pocket system comprises a large center pocket, an accessory pocket, and a plurality of accessory holders wherein
said large center pocket is between 2″ and 3″ deep with a hard outer cover that is between 1½″ and 2″ deep to form sides to prevent items from falling in the water when opened, that opens from the bottom around the top to make the top become a shelf;
said accessory pocket is adjacent to said large center pocket, is made of waterproof breathable fabric, and is between 2″ and 3″ deep;
said accessory holders are strips made from waterproof, breathable fabric that are sewn on each end of each accessory holder to the wader horizontally forming loops, each loop suitable for holding accessories such as scissors;
with an accessory insert sheaf that an accessory can fit into that has a flap that fits into the accessory holder securely holding the accessory.

6. The outfit of claim 5, wherein the large center pocket and the accessory pocket are fastened and held closed using magnets.

7. The outfit of claim 5, wherein the large center pocket and the accessory pocket are fastened and held closed using one or more hook and loop fasteners.

8. The outfit of claim 6 or claim 7, wherein the large center pocket contains an insert that is suitable for holding accessories such as fishing lures, fishing flys, and tools.
